(19) United States
(12) Patent Application Publication
(10) Pub. No.: US 2026/0365539 A1
(43) Pub. Date: Nov. 19, 2026

(54) METHOD FOR MANUFACTURING NCM ELECTRODE PARTICLES HAVING INTERPHASE LAYER AND NITROGEN-CONTAINED CARBON LAYER

(71) Applicant: Shenzhen TXD Technology Co., Ltd., Shenzhen (CN)

(72) Inventor: ZHI FENG LUO, Shenzhen (CN)

(73) Assignee: Shenzhen TXD Technology Co., Ltd., Shenzhen (CN)

(21) Appl. No.: 19/207,412

(22) Filed: May 14, 2025

(51) Int. Cl. C01G 53/44; H01M 4/36; H01M 4/505; H01M 4/525; H01M 4/62

(52) U.S. Cl. CPC C01G 53/44; H01M 4/366; H01M 4/505; H01M 4/525; H01M 4/628; C01P 2004/84; C01P 2006/40

(57) ABSTRACT

A method for manufacturing NCM electrode particles having an interphase layer and a nitrogen-contained carbon layer includes the following steps. Step A: mixing plural NCM composite particles and a methanol to form a first mixed slurry. Each NCM composite particle has the interphase layer. Step B: stirring the first mixed slurry, a tris material and a tris(hydroxymethyl)aminomethane hydrochloride to form a second mixed slurry including the NCM composite particles coated with a hydroxide ion (OH⁻) layer. Step C: stirring the second mixed slurry and a dopamine hydrochloride to form a third mixed slurry including the NCM composite particles which has a dopamine layer coated on the hydroxide ion layer. Step D: drying the third mixed slurry to obtain a mixed powder. Step E: performing a calcination on the mixed powder to form the NCM electrode particles coated with the nitrogen-contained carbon layer.

### FIELD OF THE INVENTION

The present invention is related to electrolyte particles, and in particular to a method for manufacturing NCM electrode particles having an interphase layer and a nitrogen-contained carbon layer.

### BACKGROUND OF THE INVENTION

A typical battery is mainly formed by the positive and negative electrodes placed in the electrolyte. The positive electrode is made by mixing and dispersing a large number of positive conductive units (positive electrode material, such as lithium cobalt oxide) in a positive slurry. The positive conductive units are connected to each other through the conductive slurry. Therefore, the conductive slurry must have enough conductivity in order to enable free electrons to migrate in different positive conductive units and do not have to consume too much energy due to the internal resistance, which achieves the purpose of effective conductivity. As a result, it is necessary to use a specific conductive material to make the slurry to adjust the conductivity.

To increase the conductivity, the positive slurry is filled with plural positive electrode particles which may be formed by NCM (lithium nickel manganese cobalt oxide) or LMFP (lithium manganese iron phosphate) mixtures. However, the interface of traditional positive electrode particles is easy to perform a side reaction and reduce the life of positive electrode, and also easy to degrade in the sintering during the manufacturing, resulting in a lower electrical conductivity and a poor battery performance.

### SUMMARY OF THE INVENTION

Accordingly, for improving above mentioned defects in the prior art, the object of the present invention is to provide a method for manufacturing NCM electrode particles having an interphase layer and a nitrogen-contained carbon layer, wherein the interphase layer is coated on the outer surface of the NCM particle to reduce the risk of degradation of the NCM particle due to the inert gases used in the manufacturing of NCM electrode particle. The interphase layer also can increase the lithium-ion conductivity. Furthermore, the nitrogen-contained carbon layer is coated on the outer side of the interphase layer to increase the electrical conductivity of the NCM electrode particle.

To achieve above object, the present invention provides a method for manufacturing NCM electrode particles having an interphase layer and a nitrogen-contained carbon layer; the NCM electrode particles being used in an electrode of a solid-state battery or semi-solid battery; the method comprising the steps of: step A: placing a plurality of NCM (lithium nickel manganese cobalt oxide) composite particles and a methanol into a wet mixer and then mixing the NCM composite particles and the methanol to form a first mixed slurry at a first rotation speed using the wet mixer; wherein each of the NCM composite particles includes a NCM particle and an interphase layer coated on an outer surface of the NCM particle; the interphase layer includes a glass phase layer and a plurality of ceramic particles dispersed within the glass phase layer; the interphase layer serves to protect a corresponding NCM particle and increase the lithium ion conducting effect; the glass phase layer serves to block a direct contact between the corresponding NCM particle and the electrolyte of the battery and reduce the interface side reaction; and the glass phase layer serves to reduce an interface impedance of lithium ions entering and exiting the corresponding NCM particle; step B: placing a tris (tris(hydroxymethyl)aminomethane, (HOCH₂)₃CNH₂) material and a tris(hydroxymethyl)aminomethane hydrochloride (NH₂C(CH₂OH)₃·HCl) into the wet mixer, and then stirring the first mixed slurry, the tris material and the tris(hydroxymethyl)aminomethane hydrochloride at a second rotation speed to form a second mixed slurry using the wet mixer; wherein after the stirring, an outer surface of each of the NCM composite particles is coated with a hydroxide ion (OH⁻) layer containing a plurality of OH⁻ ions; the second rotation speed of the wet mixer is larger than the first rotation speed in the step A; and the tris(hydroxymethyl)aminomethane hydrochloride serves to control a pH value of a chemical reaction in the step B; step C: placing a dopamine hydrochloride ((HO)₂C₆H₃CH₂CH₂NH₂·HCl) into the wet mixer and stirring the second mixed slurry and the dopamine hydrochloride to form a third mixed slurry using the wet mixer; wherein in the stirring, a polymerization triggered by dehydration is performed between OH⁻ ions of the dopamine molecules in the dopamine hydrochloride and the OH ions of the hydroxide ion layer to cause that each of the NCM composite particles is bound to a plurality of corresponding dopamine molecules; and the corresponding dopamine molecules are co-polymerized to form a dopamine layer coated on an outer side of the hydroxide ion layer on the corresponding NCM composite particle; step D: drying the third mixed slurry having the NCM composite particles coated with the dopamine layer to obtain a mixed powder; and step E: placing the mixed powder into a sintering furnace, and then performing a calcination in an inert atmosphere using the sintering furnace to form the NCM electrode particles; wherein in the calcination, a dehydration reaction is performed between the OH⁻ ions and the oxygen in the hydroxide ion layer and the dopamine layer to form a plurality of nitrogen-contained carbon molecules; the nitrogen-contained carbon molecules are bound to the lone pairs of the oxygen ions of the interphase layer on each NCM composite particle by a van der Waals force, forming a nitrogen-contained carbon layer coated on the outer side of each NCM composite particle; each of the NCM electrode particles is formed by a corresponding NCM composite particle coated with the interphase layer and the nitrogen-contained carbon layer; and the nitrogen-contained carbon layer serves to increase the electrical conductivity of the NCM electrode particle.

### BRIEF DESCRIPTION OF THE DRAWINGS

FIG. 1 is a steps flow diagram showing the manufacturing of the NCM electrode particles of the present invention.

FIG. 2 is a schematic view showing the manufacturing of the NCM electrode particles of the present invention.

FIG. 3 is an enlarged schematic view showing the full structure and the partial structure of the NCM composite particle of the present invention.

FIG. 4 is a cross-section view showing the structure of the NCM composite particle of the present invention.

FIG. 5 is another schematic view showing the full structure and the partial structure of the NCM composite particle coated with the hydroxide ion layer.

FIG. 6 is another schematic view showing the full structure and the partial structure of the NCM composite particle, wherein the dopamine layer is coated on the outer surface of the hydroxide ion layer.

FIG. 7 is a schematic view showing the full structure and the partial structure of the NCM electrode particle of the present invention.

FIG. 8 is a cross-section view showing the structure of the NCM electrode particle of the present invention.

FIG. 9 is a schematic view showing an application of the present invention.

FIG. 10 is a schematic view showing the structure of the second order NCM electrode particle of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

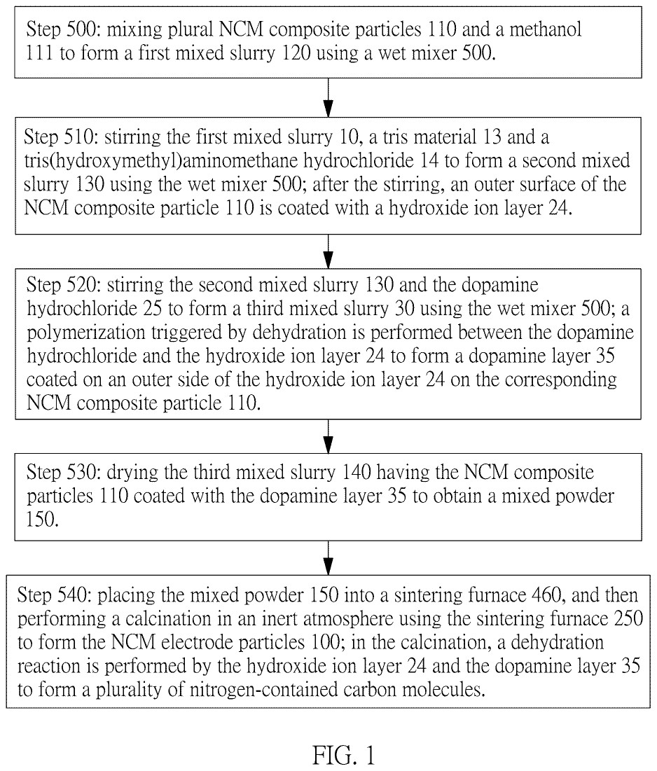

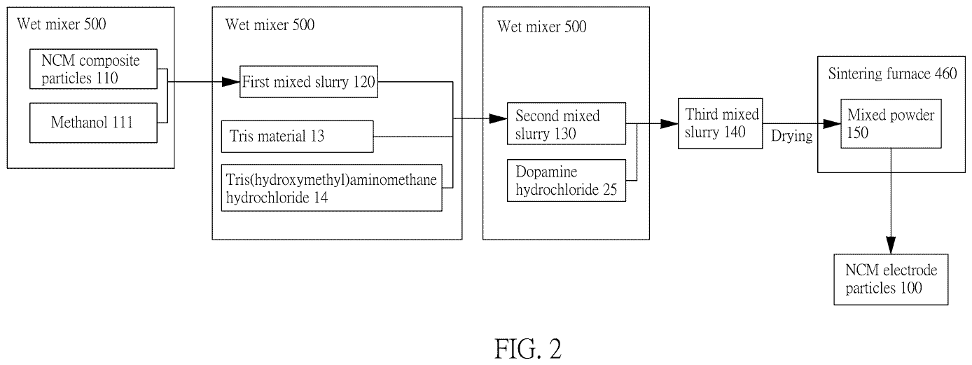

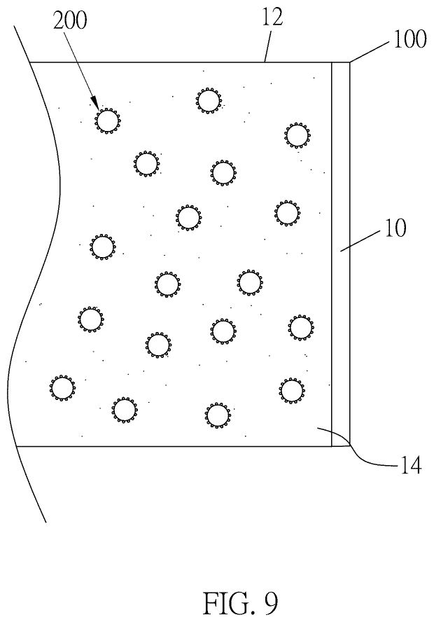

With reference to FIGS. 1 to 10, the present invention provides a method for manufacturing NCM electrode particles 100 having an interphase layer and a nitrogen-contained carbon layer. Referring to FIG. 9, the NCM electrode particles 100 are used in an electrode 10 of a solid-state battery or semi-solid battery. In application, the NCM electrode particles 100 can be arranged within the electrode 10. Preferably, the electrode 10 is a positive (+) electrode. The NCM electrode particle 100 has a particle size less than 10 μm. The electrode 10 includes a positive substrate 11 and a positive slurry layer 17 coated on the positive substrate 11. The positive slurry layer 17 includes the NCM electrode particles 100 and a positive electrode slurry 12 which is used as a binder. A weight percentage of the NCM electrode particles 100 in the positive slurry layer 17 is 80 wt %~98 wt %.

Referring to FIG. 1, the method of the present invention includes the following steps of:

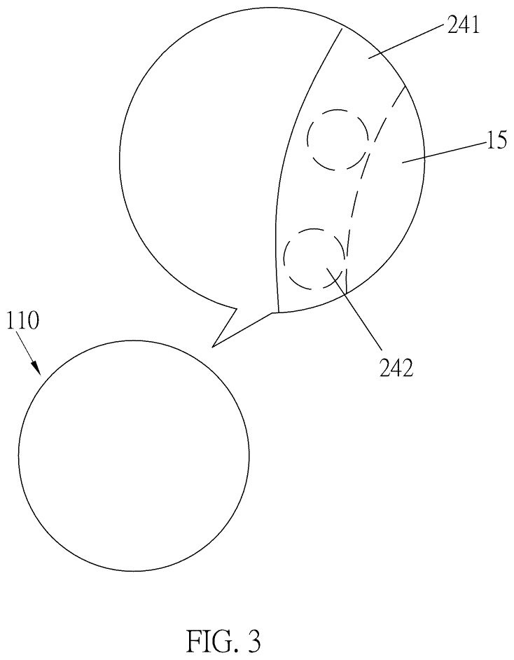

Step 500: placing a plurality of NCM (lithium nickel manganese cobalt oxide) composite particles 110 and a methanol 111 into a wet mixer 500 and then mixing the NCM composite particles 110 and the methanol 111 to form a first mixed slurry 120 at a first rotation speed using the wet mixer 500. Each of the NCM composite particles 110 includes a NCM particle 15 and an interphase layer 16 coated on an outer surface of the NCM particle 15 (as shown in FIG. 3). NCM is a ternary oxide. A D50 (mass-median-diameter, MMD) value of the NCM particle 15 is 3~5 μm. A D90 of the NCM particle 15 is not larger than 10 μm. The NCM particle 15 has a single crystal structure. The NCM particle 15 has a cube structure having an irregular three-dimensional shape. A radial thickness of the interphase layer 16 is 50 nm to 1 μm. A ratio of a total weight of the NCM composite particles 110 and a weight of the methanol 111 is 1:3 to 1:10.

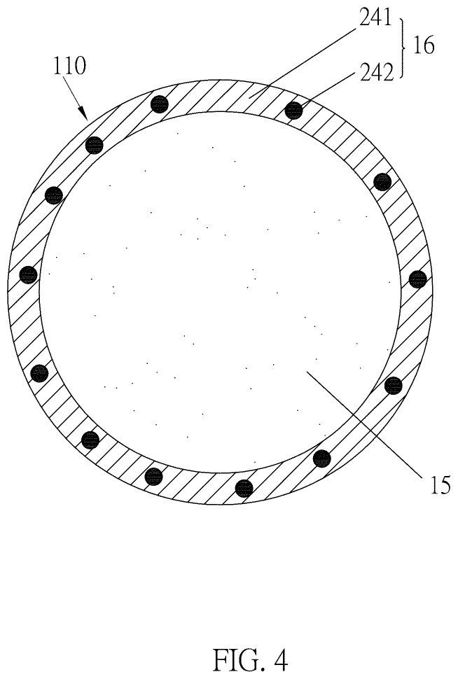

Referring to FIG. 4, the interphase layer 16 includes a glass phase layer 241 and a plurality of ceramic particles 242 dispersed within the glass phase layer 241. The interphase layer 16 serves to protect a corresponding NCM particle 15 and increase the lithium ion conducting effect. A particle size of each of the ceramic particles 242 is less than 100 nm. A radial thickness of the glass phase layer 241 is 50 nm to 1 μm. In the interphase layer 16 of each of the NCM composite particles 110, a ratio of a total weight of the ceramic particles 242 and a weight of the glass phase layer 241 is 10~1: 1~10.

The glass phase layer 241 is formed by an amorphous oxide which is formed by heat treating and has a lithium ion conductivity higher than 10⁻5 S/cm (Siemens per centimeter). The amorphous oxide can be a lithium-contained oxide or an amorphous oxide-based solid-state electrolyte. The lithium-contained oxide is formed by lithium (Li) and a chemical element in group IIIA (boron group), group IVA (carbon group) or group VA (nitrogen group) of a periodic table. The lithium-contained may be Li₂O—ROₓ, wherein x=1~3, and R is selected from boron (B), aluminum (Al), silicon (Si), germanium (Ge), phosphorus (P) and arsenic (As).

The amorphous oxide-based solid-state electrolyte is selected from at least one of an amorphous perovskite solid-state electrolyte (Li-La-Ti-O, lithium lanthanum titanium oxide, LLTO)), a garnet-based solid-state electrolyte (such as Li-La-Zr-O, lithium lanthanum zirconium oxide, LLZO), a lithium phosphorus oxynitride (LiPON), and lithium aluminum titanium phosphate (LATP).

The glass phase layer 241 has an unspecified element arrangement. The glass phase layer 241 is a continuous thin film layer coated on the outer surface of the corresponding NCM particle 15.

The ceramic particles 242 are formed by an oxide with a protective effect (such as Al₂O₃ or SiOₓ (0<x≤2)), or are formed by a ceramic oxide capable of increasing the lithium ion conductivity, such as a solid electrolyte material.

The solid electrolyte material is formed by a first oxide or phosphate capable of conducting lithium ions, or is formed by a second oxide with a garnet structure or a perovskite structure. A lithium ion conductivity of the first oxide or phosphate is higher than 10⁻5 cm²/s (diffusion coefficient). The first oxide or phosphate may be LATP (lithium aluminum titanium phosphate) with a NASICON (sodium (Na) super ionic conductor) structure, LAGP (lithium aluminium germanium phosphate), or lithiophosphate (Li₃PO₄). The second oxide with the garnet structure or the perovskite structure may be LLZO (Li₇La₃Zr₂O₁₂, lithium lanthanum zirconium oxide) or LLTO (lithium lanthanum titanium oxide). The ceramic particles 242 can be formed by combination of above materials with any ratio.

The glass phase layer 241 serves to block a direct contact between the corresponding NCM particle 15 and the electrolyte of the battery and reduce the interface side reaction. The glass phase layer 241 serves to reduce an interface impedance of lithium ions entering and exiting the corresponding NCM particle 15 and improve a C-rate (charge and discharge rates) performance. The glass phase layer 241 also serves to accommodate a volumetric change of a charging and discharging, and to improve mechanical properties of the powder formed by the corresponding NCM particle 15, and reduce the fragmentation of the powder.

The wet mixer 500 has a plurality of zirconium balls for mixing. The first rotation speed of the wet mixer 500 is 2200 rpm±20%. Each of the first zirconium balls has a grain size of 0.7 mm to 0.9 mm. A filling ratio of a total volume of the zirconium balls is 70% to 90%, which is a ratio of the total volume of the zirconium balls to a mixing volume of the wet mixer 500. A mixing time of the wet mixer 500 is 1 to 1.5 hours. An operation temperature of the wet mixer 500 is 20 °C±4 °C.

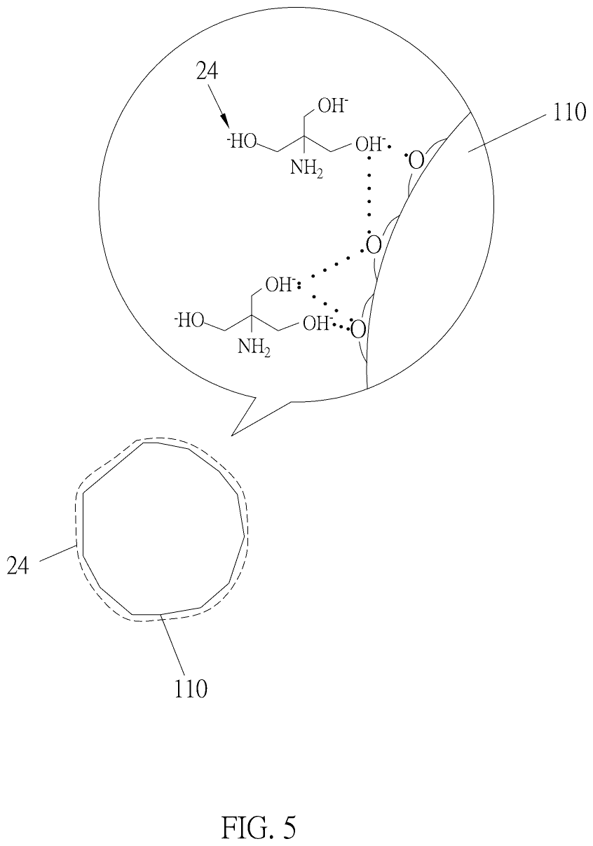

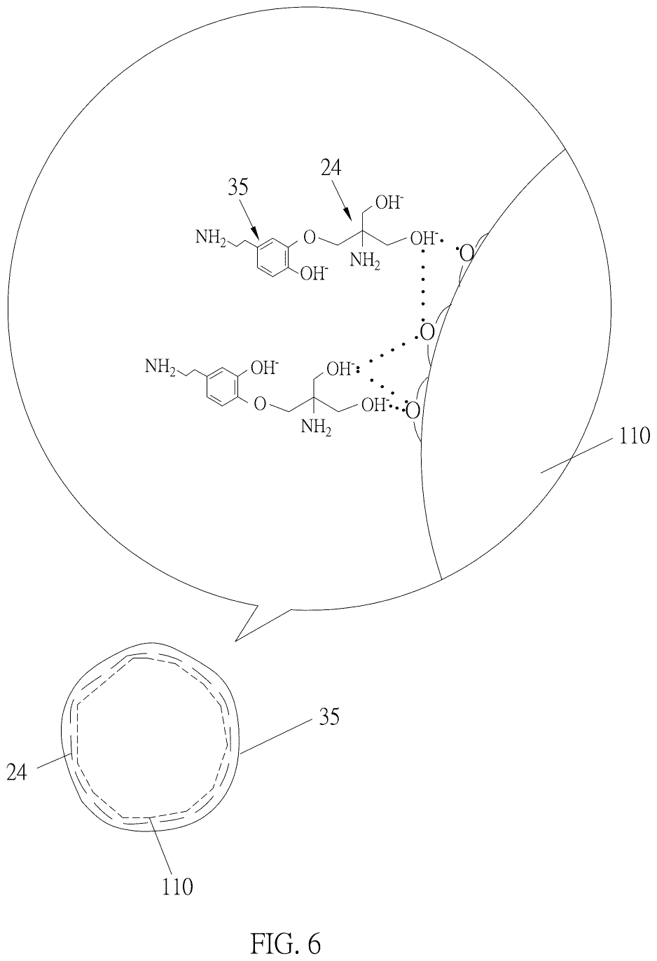

Step 510: placing a tris (tris(hydroxymethyl)aminomethane, (HOCH₂)₃CNH₂) material 13 and a tris(hydroxymethyl)aminomethane hydrochloride (NH₂C(CH₂OH)₃·HCl) 14 into the wet mixer 500, and then stirring the first mixed slurry 10, the tris material 13 and the tris(hydroxymethyl)aminomethane hydrochloride 14 at a second rotation speed to form a second mixed slurry 130 using the wet mixer 500. After the stirring, an outer surface of each of the NCM composite particles 110 is coated with a hydroxide ion (OH⁻) layer 24 containing a plurality of OH⁻ ions. Referring to FIG. 5, an outer surface of the interphase layer 16 of each of the NCM composite particles 110 has lone pairs (pairs of valence electrons) of oxygen ions. The OH⁻ ions of the hydroxide ion layer 24 are OH⁻ ions of tris molecules in the tris material 13 and the tris(hydroxymethyl)aminomethane hydrochloride 14. The OH⁻ ions on each of the tris molecules are a first OH⁻ ion, a second OH⁻ ion and the third OH⁻ ion. The first OH⁻ ions and the second OH⁻ ions of the tris molecules are bound to the lone pairs of oxygen ions on a corresponding NCM composite particle 110 by hydrogen bonding. The third OH⁻ ions of the tris molecules extend outward to an outer side of the corresponding NCM composite particle 110. FIG. 6 shows an example of only two tris molecules, while it is not used to limit the scope of the present invention.

A ratio of a weight of the tris material 13 and a weight of the tris(hydroxymethyl)aminomethane hydrochloride 14 is 8:2. A thickness of the hydroxide ion layer 24 is 0.5 nm to 2 nm.

In the step 510, the second rotation speed of the wet mixer 500 is larger than the first rotation speed in the step 500. That is, the rotation speed of the wet mixer 500 is increased from the first rotation speed to the second rotation speed in the step 510. In the step 510, the second rotation speed is 2400 rpm±20%. A stirring time of the wet mixer 500 is 0.5 hour. An operation temperature of the wet mixer 500 is 20 °C ±4 °C.

The purpose of adding the tris(hydroxymethyl)aminomethane hydrochloride 14 is to control the pH value of the chemical reaction in the step 510. Because the chemical reaction of the NCM composite particles 110 and the tris molecules needs to be catalyzed under alkaline, however if the alkalinity is too high, it will also cause hydrolysis and deterioration of the NCM composite particles 110. Therefore, by adding the tris(hydroxymethyl)aminomethane hydrochloride 14, the pH value can be decreased to lower the alkalinity in the chemical reaction.

Step 520: placing a dopamine hydrochloride ((HO)₂C₆H₃CH₂CH₂NH₂·HCl) 25 into the wet mixer 500 and then stirring the second mixed slurry 130 and the dopamine hydrochloride 25 to form a third mixed slurry 30 using the wet mixer 500. In the stirring, a polymerization triggered by dehydration is performed between OH⁻ ions of the dopamine molecules in the dopamine hydrochloride and the OH⁻ ions of the hydroxide ion layer 24 to cause that each of the NCM composite particles 110 is bound to a plurality of corresponding dopamine molecules. Referring to FIG. 6, the corresponding dopamine molecules are co-polymerized to form a dopamine layer 35 coated on an outer side of the hydroxide ion layer 24 on the corresponding NCM composite particle 110. A thickness of the dopamine layer 35 is 10 nm~200 nm.

A ratio of the total weight of the NCM composite particles 110, a total weight of the tris material 13 and the tris(hydroxymethyl)aminomethane hydrochloride 14, and a weight of the dopamine hydrochloride 25 is 100~1000:0.8~1:2.2~2.4.

Step 530: drying the third mixed slurry 140 having the NCM composite particles 110 coated with the dopamine layer 35 to obtain a mixed powder 150. The drying is performed by using a vacuum oven, using a rotary evaporator, or using a spray drying to evaporate and remove liquid (such as the methanol 111) in the third mixed slurry 140.

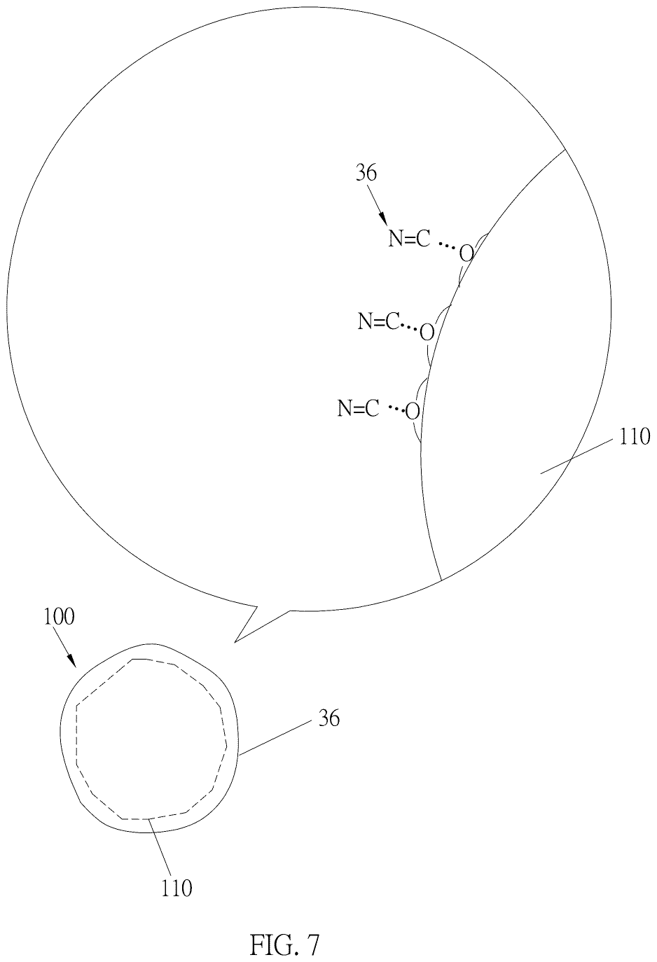

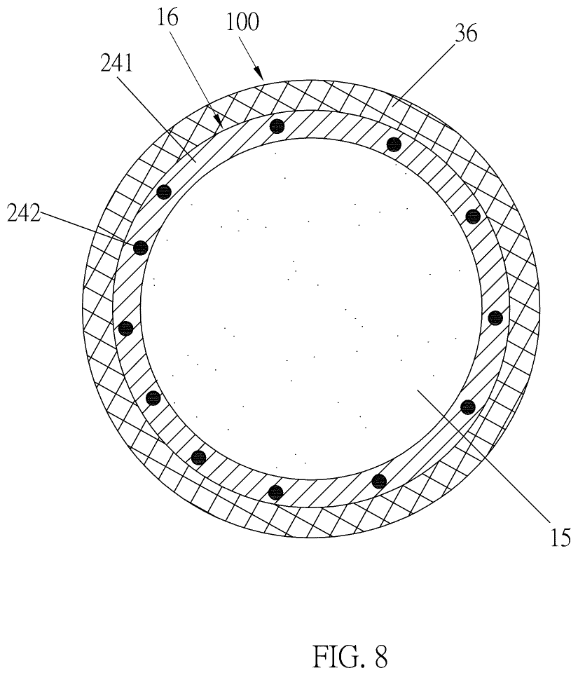

Step 540: placing the mixed powder 150 into a sintering furnace 460, and then performing a calcination in an inert atmosphere using the sintering furnace 460 to form the NCM electrode particles 100. In the calcination, a dehydration reaction is performed between the OH⁻ ions and the oxygen in the hydroxide ion layer 24 and the dopamine layer 35 to form a plurality of nitrogen-contained carbon molecules. Referring to FIG. 7, the nitrogen-contained carbon molecules are highly-ordered carbon structures containing C═N double bonds (carbon-nitrogen double bonds). The nitrogen-contained carbon molecules are bound to the lone pairs of the oxygen ions of the interphase layer 16 on each NCM composite particle 110 by a van der Waals force, forming a nitrogen-contained carbon layer 36 coated on the outer side of each NCM composite particle 110. Referring to FIG. 8, each of the NCM electrode particles 100 is formed by a corresponding NCM composite particle 110 coated with the interphase layer 16 and the nitrogen-contained carbon layer 36. A radial thickness of the nitrogen-contained carbon layer 36 is less than or equal to 0.2 μm. The nitrogen-contained carbon layer 36 serves to increase the electrical conductivity of the NCM electrode particle 100.

The purpose of coating the nitrogen-contained carbon layer 36 is that, nitrogen-doped carbon molecules in the nitrogen-containing carbon layer 35 serves to increase an electronical conductivity and a lithium-ion conductivity of the NCM particles 15, and to change an electrical potential of the NCM particles 15, and thus improves the performance of the entire battery. The nitrogen-contained carbon layer 36 is formed by a calcination of a nitrogen-contained polymer material (the dopamine hydrochloride 25) in an inert atmosphere, which is coated on the outer side of the NCM composite particle 110. The carbon and nitrogen form conjugated C═N bonds to change the energy band and to reduce the required energy for exciting electrons to the conduction band, which increases the electrical conductivity. The dopamine hydrochloride 25 using in the step 520 also can be other nitrogen-contained polymer materials, such as polydopamine (PDA).

After the calcination of the step 540, A D50 value of each of NCM particles 15 is 3~5 μm. A radial thickness of the interphase layer 16 is 50 nm to 1 μm. A particle size of each of the ceramic particles 242 is less than 100 nm. A radial thickness of the nitrogen-contained carbon layer 36 is less than or equal to 0.2 μm.

Step 550: performing a mechanical crushing on the NCM electrode particles 100, and then sifting the NCM electrode particles 100 using a sifter. The sifter has a mesh of 500.

The present invention further includes the following steps of:

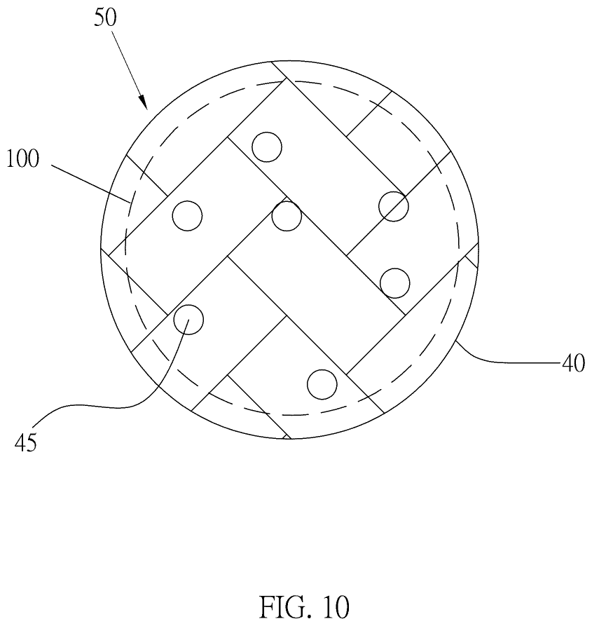

Step 560: coating a carbon material on outer surfaces of the NCM electrode particles 100 to form a plurality of second order NCM composite electrode particle 50 for increasing the electrical conductivity. Referring I to FIG. 10, the carbon material includes a plurality of carbon nanotubes 40 and a plurality of nanoscale amorphous carbons 45 (as shown in FIG. 10).

Each of the carbon nanotubes 40 has a length of 200~500 nm. Each of the nanoscale amorphous carbons 45 has a length of 10~40 nm. The nanoscale amorphous carbons 45 are amorphous carbons of a Super P auxiliary agent. A ratio of a total weight of the carbon nanotubes 40 and the nanoscale amorphous carbons 45, and a weight of the NCM particle 15 is 0.2~2:99.8~98.

The carbon nanotubes 40 serve to increase the conductivity of the electrons. The carbon nanotubes 40 are randomly distributed on outer surfaces of the NCM electrode particle 100. The carbon nanotubes 40 have an extremely high electrical conductivity, so that the electrons can pass through the carbon nanotubes 40 and conduct between different NCM electrode particles 100, which increase the electrical conductivity of the electrode 10.

The carbon nanotubes 40 and the nanoscale amorphous carbons 45 are used as an auxiliary agent. The nanoscale amorphous carbons 45 are in a form of particles, and the carbon nanotubes 40 are in a form of long strips, and the nanoscale amorphous carbons 45 are filled in the gaps formed between the carbon nanotubes 40 to transmit the electric charge between the carbon nanotubes 40 through the spanning of the nanoscale amorphous carbons 45, which further increases the transmitting efficiency of the electric current.

The advantages of the present invention are that, the interphase layer is coated on the outer surface of the NCM particle to reduce the risk of degradation of the NCM particle due to the inert gases used in the manufacturing of NCM electrode particle. The interphase layer also can increase the lithium-ion conductivity. Furthermore, the nitrogen-contained carbon layer is coated on the outer side of the interphase layer to increase the electrical conductivity of the NCM electrode particle.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for manufacturing NCM electrode particles having an interphase layer and a nitrogen-contained carbon layer; the NCM electrode particles being used in an electrode of a solid-state battery or semi-solid battery; the method comprising the steps of:
step A: placing a plurality of NCM (lithium nickel manganese cobalt oxide) composite particles and a methanol into a wet mixer and then mixing the NCM composite particles and the methanol to form a first mixed slurry at a first rotation speed using the wet mixer; wherein each of the NCM composite particles includes a NCM particle and the interphase layer coated on an outer surface of the NCM particle; the interphase layer includes a glass phase layer and a plurality of ceramic particles dispersed within the glass phase layer; the interphase layer serves to protect a corresponding NCM particle and increase the lithium ion conducting effect; the glass phase layer serves to block a direct contact between the corresponding NCM particle and the electrolyte of the battery and reduce the interface side reaction; and the glass phase layer serves to reduce an interface impedance of lithium ions entering and exiting the corresponding NCM particle;
step B: placing a tris (tris(hydroxymethyl)aminomethane, (HOCH₂)₃CNH₂) material and a tris(hydroxymethyl)aminomethane hydrochloride (NH₂C(CH₂OH)₃·HCl) into the wet mixer, and then stirring the first mixed slurry, the tris material and the tris(hydroxymethyl)aminomethane hydrochloride at a second rotation speed to form a second mixed slurry using the wet mixer; wherein after the stirring, an outer surface of each of the NCM composite particles is coated with a hydroxide ion (OH⁻) layer containing a plurality of OH⁻ ions; the second rotation speed of the wet mixer is larger than the first rotation speed in the step A; and the tris(hydroxymethyl)aminomethane hydrochloride serves to control a pH value of a chemical reaction in the step B;
step C: placing a dopamine hydrochloride ((HO)₂C₆H₃CH₂CH₂NH₂·HCl) into the wet mixer and stirring the second mixed slurry and the dopamine hydrochloride to form a third mixed slurry using the wet mixer; wherein in the stirring, a polymerization triggered by dehydration is performed between OH⁻ ions of the dopamine molecules in the dopamine hydrochloride and the OH⁻ ions of the hydroxide ion layer to cause that each of the NCM composite particles is bound to a plurality of corresponding dopamine molecules; and the corresponding dopamine molecules are co-polymerized to form a dopamine layer coated on an outer side of the hydroxide ion layer on the corresponding NCM composite particle;
step D: drying the third mixed slurry having the NCM composite particles coated with the dopamine layer to obtain a mixed powder; and
step E: placing the mixed powder into a sintering furnace, and then performing a calcination in an inert atmosphere using the sintering furnace to form the NCM electrode particles; wherein in the calcination, a dehydration reaction is performed between the OH⁻ ions and the oxygen in the hydroxide ion layer and the dopamine layer to form a plurality of nitrogen-contained carbon molecules; the nitrogen-contained carbon molecules are bound to the lone pairs of the oxygen ions of the interphase layer on each NCM composite particle by a van der Waals force, forming the nitrogen-contained carbon layer coated on the outer side of each NCM composite particle; each of the NCM electrode particles is formed by a corresponding NCM composite particle coated with the interphase layer and the nitrogen-contained carbon layer; and the nitrogen-contained carbon layer serves to increase the electrical conductivity of the NCM electrode particle.

2. The method as claimed in claim 1, wherein the nitrogen-contained carbon molecules are highly-ordered carbon structures containing C═N double bonds (carbon-nitrogen double bonds).

3. The method as claimed in claim 1, wherein the glass phase layer is formed by an amorphous oxide which is formed by heat treating and has a lithium ion conductivity higher than 10⁻⁵ S/cm (Siemens per centimeter); the glass phase layer has an unspecified element arrangement; and the glass phase layer is a continuous thin film layer coated on the outer surface of the corresponding NCM particle.

4. The method as claimed in claim 3, wherein the amorphous oxide is formed by an amorphous oxide-based solid-state electrolyte.

5. The method as claimed in claim 4, wherein the amorphous oxide-based solid-state electrolyte is selected from an amorphous perovskite solid-state electrolyte, a garnet-based solid-state electrolyte, a lithium phosphorus oxynitride (LiPON), and lithium aluminum titanium phosphate (LATP).

6. The method as claimed in claim 1, wherein the ceramic particles are formed by an oxide with a protective effect, or a ceramic oxide capable of increasing the lithium ion conductivity.

7. The method as claimed in claim 6, wherein the oxide with the protective effect is selected from Al₂O₃ or SiOₓ, wherein 0<x≤2; the ceramic oxide capable of increasing the lithium ion conductivity is a solid electrolyte material; and
wherein the solid electrolyte material is formed by a first oxide or phosphate capable of conducting lithium ions, or is formed by a second oxide with a garnet structure or a perovskite structure; a lithium ion conductivity of the first oxide or phosphate is higher than 10⁻⁵ cm²/s (diffusion coefficient); the first oxide or phosphate may be LATP (lithium aluminum titanium phosphate) with a NASICON (sodium (Na) super ionic conductor) structure, LAGP (lithium aluminium germanium phosphate), or lithiophosphate (Li₃PO₄); and the second oxide with the garnet structure or the perovskite structure may be LLZO (Li₇La₃Zr₂O₁₂, lithium lanthanum zirconium oxide) or LLTO (lithium lanthanum titanium oxide).

8. The method as claimed in claim 1, wherein each of the NCM electrode particles has a particle size less than 10 μm; a D50 (mass-median-diameter, MMD) value of the NCM particle is 3~5 μm; the NCM particle has a single crystal structure; a radial thickness of the interphase layer is 50 nm to 1 μm; a ratio of a total weight of the NCM composite particles and a weight of the methanol is 1:3 to 1:10; a particle size of each of the ceramic particles is less than 100 nm; a radial thickness of the glass phase layer is 50 nm to 1 μm; and in the interphase layer of each of the NCM composite particles, a ratio of a total weight of the ceramic particles and a weight of the glass phase layer is 10~1:1~10.

9. The method as claimed in claim 1, wherein the wet mixer has a plurality of zirconium balls for mixing; the first rotation speed of the wet mixer is 2200 rpm±20%; each of the first zirconium balls has a grain size of 0.7 mm to 0.9 mm; a filling ratio of a total volume of the zirconium balls is 70% to 90%, which is a ratio of the total volume of the zirconium balls to a mixing volume of the wet mixer; a mixing time of the wet mixer is 1 to 1.5 hours; and an operation temperature of the wet mixer is 20 °C±4 °C.

10. The method as claimed in claim 1, wherein in the step B, the OH⁻ ions of the hydroxide ion layer are OH⁻ ions of tris molecules in the tris material and the tris(hydroxymethyl)aminomethane hydrochloride; the OH⁻ ions on each of the tris molecules are a first OH⁻ ion, a second OH⁻ ion and the third OH⁻ ion; the first OH⁻ ions and the second OH⁻ ions of the tris molecules are bound to the lone pairs of oxygen ions on a corresponding NCM composite particle by hydrogen bonding; and the third OH⁻ ions of the tris molecules extend outward to an outer side of the corresponding NCM composite particle.

11. The method as claimed in claim 1, wherein in the step B, a ratio of a weight of the tris material and a weight of the tris(hydroxymethyl)aminomethane hydrochloride is 8:2; and a ratio of the total weight of the NCM composite particles, a total weight of the tris material and the tris(hydroxymethyl)aminomethane hydrochloride, and a weight of the dopamine hydrochloride is 100~1000:0.8~1:2.2~2.4.

12. The method as claimed in claim 1, wherein a thickness of the dopamine layer is 10 nm~200 nm.

13. The method as claimed in claim 1, wherein in the step B, the second rotation speed is 2400 rpm±20%; a stirring time of the wet mixer is 0.5 hour; and an operation temperature of the wet mixer is 20 °C±4 °C.

14. The method as claimed in claim 1, wherein the drying in the step D is performed by using a vacuum oven, using a rotary evaporator, or using a spray drying to evaporate and remove liquid in the third mixed slurry.

15. The method as claimed in claim 1, wherein after the calcination of the step E, a D50 value of each of NCM particles is 3~5 μm; a radial thickness of the interphase layer is 50 nm to 1 μm; a particle size of each of the ceramic particles is less than 100 nm; and a radial thickness of the nitrogen-contained carbon layer is less than or equal to 0.2 μm.

16. The method as claimed in claim 1, further comprising the step of:
step F: performing a mechanical crushing on the NCM electrode particles; and then sifting the NCM electrode particles using a sifter.

17. The method as claimed in claim 1, further comprising the step of:
step G: coating a carbon material on outer surfaces of the NCM electrode particles to form a plurality of second order NCM composite electrode particle; wherein the carbon material includes a plurality of carbon nanotubes and a plurality of nanoscale amorphous carbons.

18. The method as claimed in claim 17, wherein each of the carbon nanotubes has a length of 200~500 nm; each of the nanoscale amorphous carbons has a length of 10~40 nm; and a ratio of a total weight of the carbon nanotubes and the nanoscale amorphous carbons, and a weight of the NCM particle is 0.2~2:99.8~98.
